(19) United States
(12) Patent Application Publication
(10) Pub. No.: US 2006/0059512 A1
(43) Pub. Date: Mar. 16, 2006

(54) Methods for controlling apparatuses having an emergency alert function

(76) Inventor: Michael Anthony Pugel, Noblesville, IN (US)

Correspondence Address: THOMSON LICENSING INC., PATENT OPERATIONS, PO BOX 5312, PRINCETON, NJ, 08543-5312, US

(21) Appl. No.: 10/535,124

(22) PCT Filed: Nov. 13, 2003
(86) PCT No.: PCT/US03/36172

§ 371 Date: May 16, 2005

Related U.S. Application Data
(60) Provisional application No. 60/426,865, filed on Nov. 15, 2002.
(60) Provisional application No. 60/426,640, filed on Nov. 15, 2002.

(51) Int. Cl. H04N 7/10

(52) U.S. Cl. 725/33

(57) ABSTRACT

An apparatus such as a television signal receiver provides an emergency alert function and an auxiliary information display function. According to an exemplary embodiment, the apparatus includes a tuner operative to tune signals including emergency alert signals associated with the emergency alert function. A processor is operative to enable a disabled user setting for the auxiliary information display function responsive to the emergency alert signals.

### CROSS REFERENCE TO RELATED APPLICATIONS

This application claims priority to and all benefits accruing from two provisional applications filed in the United States Patent and Trademark Office on Nov. 15, 2002, and there assigned Ser. Nos. 60/426,640 and 60/426,865.

### BACKGROUND OF THE INVENTION

1. Field of the Invention

The present invention generally relates to apparatuses such as television signal receivers having an emergency alert function, and more particularly, to techniques for controlling such apparatuses which increase the likelihood that users receive important information concerning emergency events.

2. Background Information

Emergency events such as severe weather, natural disasters, fires, civil emergencies, war acts, toxic chemical spills, radiation leaks, or other such conditions can be devastating to unprepared individuals. With weather-related emergencies, authorities such as the National Weather Service (NWS) and the National Oceanographic and Atmospheric Administration (NOAA) are generally able to detect severe weather conditions prior to the general public. Through the use of modern weather detection devices, such as Doppler radar and weather satellites, the NWS and NOAA are able to issue early warnings of severe weather conditions which have saved many lives. However, for such warnings to be effective, they must be communicated to their intended recipients.

Certain apparatuses are capable of receiving emergency alert signals provided by sources such as the NWS and NOAA, and provide an emergency alert function using Specific Area Message Encoding (SAME) technology. Apparatuses using SAME technology typically require a user to perform a setup process for the emergency alert function by selecting items such as one or more geographical areas of interest, and one or more types of emergency events which activate the emergency alert function. Once the setup process is complete, the emergency alert function may be activated when incoming emergency alert signals including SAME data indicate the occurrence of an emergency event which corresponds to the geographical area(s) and types of emergency event selected by the user during the setup process. When the emergency alert function is activated, an alert output such as an audio and/or visual message may be provided to alert individuals of the emergency event.

With apparatuses using technology such as SAME technology, a problem exists in that certain alert outputs may not be provided in some instances. For example, an apparatus such as a television signal receiver may include an auxiliary information display function such as a closed caption display function which may be used to provide visual alert outputs such as text messages to notify individuals of emergency events. Moreover, the auxiliary information display function may be turned on and off selectively by a user through a setup process for the normal operation of the television signal receiver. Accordingly, if the emergency alert function of the television signal receiver is activated while the auxiliary information display function is turned off, visual alert outputs notifying individuals of an emergency event may not be displayed. As a result, individuals may fail to receive important information concerning the emergency event.

Another problem may occur if the emergency alert function is activated when the television signal receiver is not receiving an operating video signal. For example, this may occur if the emergency alert function is activated while a video input of the television signal receiver is connected to another video device such as a video cassette recorder (VCR), digital versatile disk (DVD) player or other device which is turned off. In such an instance, if a visual alert output such as a text message is provided, it may be displayed over an undesirable background, such as a “snowy” background. As a result, the text message may be difficult or impossible to read and individuals may therefore fail to receive important information concerning the emergency event.

Accordingly, there is a need for techniques for providing alert outputs which avoid the foregoing problems, and thereby increase the likelihood that users receive important information concerning emergency events. The present invention addresses these and other issues.

### SUMMARY OF THE INVENTION

In accordance with an aspect of the present invention, an apparatus having an emergency alert function is disclosed. According to an exemplary embodiment, the apparatus comprises tuning means for tuning signals including emergency alert signals associated with the emergency alert function. Processing means are provided for enabling a disabled user setting for an auxiliary information display function of the apparatus responsive to the emergency alert signal.

In accordance with another aspect of the present invention, a method for controlling an apparatus having an emergency alert function is disclosed. According to an exemplary embodiment, the method comprises steps of tuning signals including emergency alert signals associated with the emergency alert function, and enabling display of a default screen responsive to the emergency alert signals.

In accordance with still another aspect of the present invention, a television signal receiver having an emergency alert function is disclosed. According to an exemplary embodiment, the television signal receiver comprises a tuner operative to tune signals including emergency alert signals associated with the emergency alert function. A processor is operative to enable a disabled user setting for an auxiliary information display function of the television signal receiver responsive to the emergency alert signals.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is an exemplary environment suitable for implementing the present invention;

FIG. 2 is a block diagram of a television signal receiver according to an exemplary embodiment of the present invention;

FIG. 3 is a block diagram providing further details of the processor and memory of FIG. 2 according to an exemplary embodiment of the present invention;

FIG. 4 is a block diagram providing further details of the video processor of FIG. 2 according to an exemplary embodiment of the present invention;

FIG. 5 is a flowchart illustrating exemplary steps according to one aspect of the present invention; and

FIG. 6 is a flowchart illustrating exemplary steps according to another aspect of the present invention.

The exemplifications set out herein illustrate preferred embodiments of the invention, and such exemplifications are not to be construed as limiting the scope of the invention in any manner.

### DESCRIPTION OF THE PREFERRED EMBODIMENTS

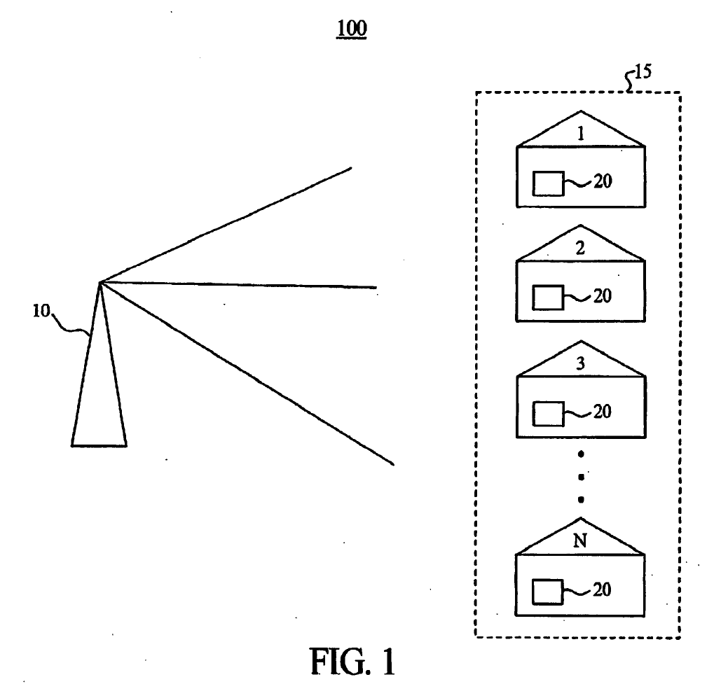

Referring now to the drawings, and more particularly to FIG. 1, an exemplary environment 100 suitable for implementing the present invention is shown. In FIG. 1, environment 100 comprises signal transmission means such as signal transmission source 10, dwelling means such as dwelling units 15 (i.e., 1, 2, 3 . . . N, where N may be any positive integer), and signal receiving means such as television signal receivers 20.

In FIG. 1, dwelling units 15 may represent residences, businesses and/or other dwelling places located within a particular geographical area, such as but not limited to, a particular continent, country, region, state, area code, zip code, city, county, municipality, subdivision, and/or other definable geographical area. According to an exemplary embodiment, each of the dwelling units 15 is equipped with at least one television signal receiver 20 having an emergency alert function. According to the present invention, the emergency alert function enables television signal receiver 20 to receive emergency alert signals and provide one or more alert outputs to notify individuals of an emergency event. As will be discussed later herein, television signal receiver 20 also includes an auxiliary information display function, such as a closed caption function, which may be used to provide a visual alert output to notify individuals of an emergency event.

According to an exemplary embodiment, signal transmission source 10 transmits signals including audio, video and/or emergency alert signals which may be received by each television signal receiver 20. According to an exemplary embodiment, the emergency alert signals may be provided from an authority such as the NWS, or other authorities such as governmental entities or the like. Signal transmission source 10 may transmit the emergency alert signals in their original form as provided by the authority, or may append digital data representative of the emergency alert signals to other data, or may modify the emergency alert signals in some manner appropriate for its specific transmission format needs. In response to the emergency alert signals, each television signal receiver 20 may provide one or more alert outputs to thereby notify individuals of the emergency event. Signal transmission source 10 may transmit signals to television signal receivers 20 via any wired or wireless link such as, but not limited to, terrestrial, cable, satellite, fiber optic, digital subscriber line (DSL), and/or any other type of broadcast and/or multicast means.

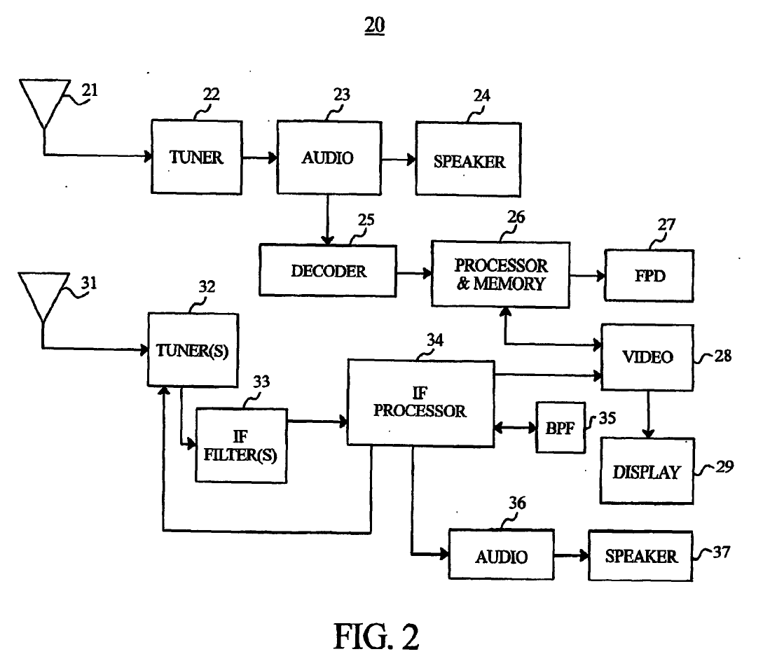

Referring to FIG. 2, a block diagram of an exemplary embodiment of television signal receiver 20 of FIG. 1 is shown. In FIG. 2, television signal receiver 20 comprises signal receiving means such as signal receiving element 21, tuning means such as tuner 22, audio processing means such as audio processor 23, audio output means such as speaker 24, decoding means such as decoder 25, processing and memory means such as processor and memory 26, display means such as front panel display (FPD) 27, video processing means such as video processor 28, display means such as display 29, signal receiving means such as signal receiving element 31, tuning means such as tuner(s) 32, intermediate frequency (IF) filtering means such as one or more IF filters 33, IF processing means such as IF processor 34, band pass filter (BPF) means such as BPF 35, audio processing means such as audio processor 36, and audio output means such as speaker 37. Some of the foregoing elements may for example be embodied using integrated circuits (ICs). For clarity of description, certain conventional elements of television signal receiver 20 including certain control signals may not be shown in FIG. 2.

Signal receiving element 21 is operative to receive signals including audio signals from signal sources, such as signal transmission source 10 in FIG. 1. According to an exemplary embodiment, received audio signals may include digitally encoded emergency alert signals. Signal receiving element 21 may be embodied as any signal receiving element such as an antenna, input terminal or other element.

Tuner 22 is operative to tune signals including audio signals provided from signal receiving element 21. According to an exemplary embodiment, tuner 22 is capable of tuning audio signals on at least the following designated NWS frequencies: 162.400 MHz, 162.425 MHz, 162.450 MHz, 162.475 MHz, 162.500 MHz, 162.525 MHz and 162.550 MHz. Other frequencies may also be tuned. As previously indicated herein, such audio signals may additionally include digitally encoded emergency alert signals.

Audio processor 23 is operative to process audio signals provided from tuner 22. According to an exemplary embodiment, audio processor 23 demodulates such audio signals to thereby generate demodulated audio signals representing audio content such as an NWS audio message, a warning alert tone and/or other audio content. Audio processor 23 is further operative to amplify the demodulated audio signals. Speaker 24 is operative to aurally output the amplified audio signals provided from audio processor 23.

Decoder 25 is operative to decode signals including demodulated audio signals provided from audio processor 23. According to an exemplary embodiment, decoder 26 decodes such audio signals to thereby extract digitally encoded frequency shift keyed (FSK) signals, which represent emergency alert signals indicating an emergency event. According to this exemplary embodiment, the emergency alert signals include data comprising specific area message encoding (SAME) data associated with the emergency event. SAME data comprises a digital code representing information such as the specific geographical area affected by the emergency event, the type of emergency event (e.g., tomado, toxic chemical spill, radiation leak, civil emergency, etc.), and the expiration time of the event alert. SAME data is used by the NWS and other authorities to improve the specificity of emergency alerts and to decrease the frequency of false alerts. Other data and information may also be included in the emergency alert signals according to the present invention.

Processor and memory 26 are operative to perform various processing and data storage functions of television signal receiver 20. According to an exemplary embodiment, processor 26 receives the emergency alert signals from decoder 25 and determines whether the emergency alert function of television signal receiver 20 is activated based on data included in the emergency alert signals. According to this exemplary embodiment, processor 26 compares data in the emergency alert signals to data stored in memory 26 to determine whether the emergency alert function is activated. As will be described later herein, a setup process for the emergency alert function of television signal receiver 20 allows a user to select items such as an applicable geographical area(s), and type(s) of emergency events (e.g., tornado watch, radiological hazard warning, civil emergency, etc.) which activate the emergency alert function.

According to an exemplary embodiment, when the emergency alert function is activated, processor 26 outputs one or more control signals which enable various operations. According to an exemplary embodiment, such control signals may enable a disabled user setting for an auxiliary information display function, such as a closed caption, teletext, or other such display function, associated with television signal receiver 20. Once the auxiliary information display function is enabled, such control signals may further enable one or more alert outputs including a visual alert output, such as a text message, using the auxiliary information display function to thereby notify individuals of an emergency event. Such control signals may also enable other operations of television signal receiver 20, such as causing it to be switched from an off/standby mode to an on mode, and/or enabling display of a default (e.g., blue) screen which may be used as a background for the visual alert output provided via the auxiliary information display function. According to an exemplary embodiment, processor 26 may also perform a data slicing operation to facilitate the auxiliary information display function of television signal receiver 20 which enables auxiliary information displays such as closed caption displays, teletext displays, etc. Further details regarding the aforementioned aspects of the present invention will be provided later herein.

FPD 27 is operative to provide visual displays including information such as the operational state of the emergency alert function of television signal receiver 20, and information regarding emergency events. According to an exemplary embodiment, FPD 27 is a viewable display panel including one or more indicator elements. Such indicator elements may for example include any type of visual indicator such as light emitting diode (LED) or liquid crystal display (LCD) lamp(s), monochrome and/or colored liquid quartz display (LOD) indicators, plasma display indicators, and/or conventional lights used in consumer electronic products.

Video processor 28 is operative to process signals including video signals provided from IF processor 34. According to an exemplary embodiment, video processor 28 may process video signals having embedded auxiliary information such as NWS text messages, messages that provide information regarding emergency events, and/or other messages. As will be described later herein, video processor 28 may perform a data slicing operation to facilitate the auxiliary information display function of television signal receiver 20 which enables auxiliary information displays such as closed caption displays, teletext displays, etc. Display 29 is operative to provide visual displays corresponding to processed signals provided from video processor 28. According to an exemplary embodiment, display 29 may provide visual displays including the aforementioned messages that provide information regarding emergency events.

Signal receiving element 31 is operative to receive signals including audio and/or video signals from signal sources, such as signal transmission source 10 in FIG. 1. Signal receiving element 31 may be embodied as any signal receiving element such as an antenna, input terminal or other element.

Tuner(s) 32 includes one or more tuners and is operative to tune signals including audio and/or video signals provided from signal receiving element 31 to thereby generate IF signals. Tuner(s) 32 may include more than one tuner to facilitate a picture-in-picture (PIP) function of television signal receiver 20. According to an exemplary embodiment, tuner(s) 32 may receive an automatic gain control (AGC) signal from IF processor 34, as indicated in FIG. 2. One or more IF filters 33 are operative to filter the IF signals provided from tuner(s) 32. According to an exemplary embodiment, IF filter(s) 33 may be embodied as surface acoustic wave (SAW) filters having a split arrangement, wherein one IF filter 33 filters audio signals and another IF filter 33 filters video signals.

IF processor 34 is operative to process filtered IF signals provided from IF filter(s) 33. According to an exemplary embodiment, IF processor 34 demodulates the filtered IF signals, and provides demodulated audio and video signals to audio processor 36 and video processor 28, respectively. IF processor 34 may accommodate split audio and video IF signal inputs. BPF 35 is operative to filter audio IF signals. According to an exemplary embodiment, BPF 35 may provide a 4.5 MHz pass band and include one or more filters for optimizing television audio quality.

Audio processor 36 is operative to process audio signals provided from IF processor 34. According to an exemplary embodiment, audio processor 36 demodulates such audio signals to thereby generate demodulated audio signals. Audio processor 36 is further operative to amplify the demodulated audio signals. Speaker 37 is operative to aurally output the amplified audio signals provided from audio processor 36.

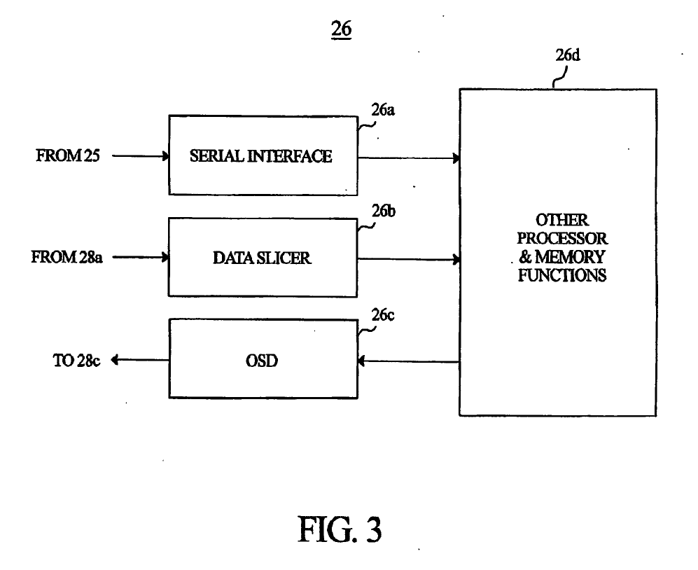

Referring now to FIG. 3, a block diagram providing further details of processor and memory 26 of FIG. 2 according to an exemplary embodiment of the present invention is shown. In particular, FIG. 3 shows an exemplary embodiment in which processor 26 may perform a data slicing operation to facilitate the auxiliary information display function of television signal receiver 20. In FIG. 3, processor and memory 26 comprise interface means such as serial interface 26a, data slicing means such as data slicer 26b, on-screen display (OSD) processing means such as OSD processor 26c, and other functional means such as other processor and memory functions 26d. According to an exemplary embodiment, the elements of processor and memory 26 shown in FIG. 3 may be embodied using an IC such as an ST92196 model available from ST Microelectronics.

Serial interface 26a is operative to receive emergency alert signals from decoder 25, and provide the received emergency alert signals to other processor and memory functions 26d for processing as previously described herein. According to an exemplary embodiment, serial interface 26a may include direct memory access (DMA) capabilities.

Data slicer 26b is operative to receive video signals from video processor 28 and perform a data slicing operation to thereby extract auxiliary information such as closed caption, teletext and/or other such information representing NWS text messages, messages that provide information regarding emergency events, and/or other messages embedded within the received video signals. Such auxiliary information may for example be extracted from the vertical blanking interval (VBI) of a television signal.

OSD processor 26c is operative to process signals including the emergency alert signals received via serial interface 26a and the auxiliary information extracted by the data slicing operation of data slicer 26b. According to an exemplary embodiment, OSD processor 26c provides digitally processed outputs such as red, green, and blue (RGB) signals along with horizontal and vertical synchronization information to video processor 28 to thereby enable auxiliary information such as closed caption, teletext and/or other such information to be displayed on top of the video. The other processor and memory functions 26d include functions such as SAME data processing, data storage, data communication (e.g., bus), control, and/or other functions.

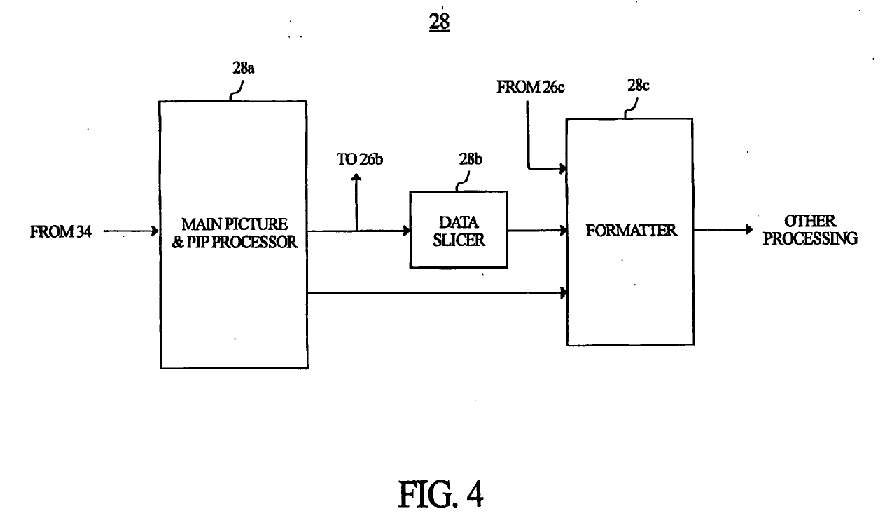

Referring now to FIG. 4, a block diagram providing further details of video processor 28 of FIG. 2 according to an exemplary embodiment of the present invention is shown. In particular, FIG. 4 shows an exemplary embodiment in which video processor 28 may perform a data slicing operation to facilitate the auxiliary information display function of television signal receiver 20. In FIG. 4, video processor 28 comprises picture processing means such as main picture and PIP processor 28a, data slicing means such as data slicer 28b, and data formatting means such as formatter 28c. According to an exemplary embodiment, the elements of video processor 28 shown in FIG. 4 may be embodied using an IC such as a VY22402B model available from Phillips.

Main picture and PIP processor 28a is operative to receive and process the video signals provided from IF processor 34 for a main picture and a PIP. According to an exemplary embodiment, main picture and PIP processor 28a performs functions such as analog-to-digital conversion, adaptive comb filtering, chrominance demodulation, sample rate conversion, synchronization processing, and/or other functions.

Data slicer 28b is operative to receive video signals from main picture and PIP processor 28a and perform a data slicing operation to thereby extract auxiliary information such as closed caption, teletext, and/or other such information representing NWS text messages, messages that provide information regarding emergency events, and/or other messages embedded within the received video signals. Such auxiliary information may for example be extracted from the VBI of a television signal. Data slicer 28b provides the extracted auxiliary information to formatter 28c. It is noted that the data slicing operation may be performed by processor 26 or video processor 28. Accordingly, if processor 26 includes data slicer 26b as shown in FIG. 3, then data slicer 28b may be omitted from video processor 28 in FIG. 4. Conversely, if video processor 28 includes data slicer 28b as shown in FIG. 4, then data slicer 26b may be omitted from processor 26 in FIG. 3.

Formatter 28c is operative to format digital signals including the processed outputs from OSD processor 26c, the auxiliary information from data slicer 28b, and the processed video signals from main picture and PIP processor 28a. According to an exemplary embodiment, formatter 28c may include means for automatically detecting the processed outputs from OSD processor 26c, and for inserting such outputs into video signals for the main picture.

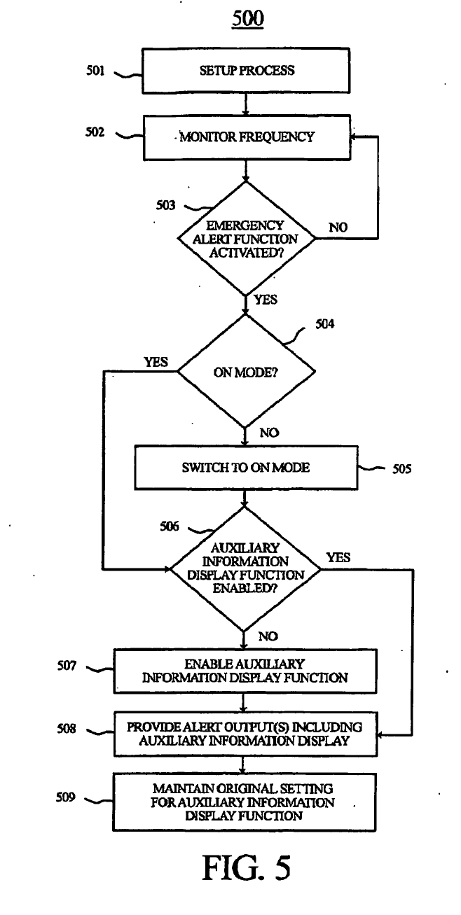

Turning now to FIG. 5, a flowchart 500 illustrating exemplary steps according to one aspect of the present invention is shown. For purposes of example and explanation, the steps of FIG. 5 will be described with reference to television signal receiver 20 of FIG. 2. The steps of FIG. 5 are merely exemplary, and are not intended to limit the present invention in any manner.

At step 501, a user setup process may be performed for various functions of television signal receiver 20. According to an exemplary embodiment, a user may perform the setup process at step 501 by providing inputs to television signal receiver 20 (e.g., using a remote control device not shown) responsive to an on-screen menu displayed via display 29. Such an on-screen menu may for example be part of an electronic program guide (EPG) function of television signal receiver 20.

According to an exemplary embodiment, the setup process of step 501 enables a user to control functions including an auxiliary display function of television signal receiver 20, such as a closed caption, teletext or other such display function, by turning the function on or off. In this manner, a user may selectively enable or disable the auxiliary display function, and thereby permit or prevent auxiliary information from being displayed. The setup process of step 501 also enables a user to make various selections regarding the emergency alert function of television signal receiver 20. According to an exemplary embodiment, the user may select at least the following items for the emergency alert function during the setup process of step 501:

A. Enable/Disable—The user may select whether to enable or disable the emergency alert function.

B. Frequency Selection—The user may select the monitoring frequency to tune to in order to receive emergency alert signals. For example, the user may select a frequency such as one of the following NWS transmission frequencies: 162.400 MHz, 162.425 MHz, 162.450 MHz, 162.475 MHz, 162.500 MHz, 162.525 MHz and 162.550 MHz. The selection of a monitoring frequency may for example be facilitated through a frequency scanning operation which scans various frequency channels to thereby identify the monitoring frequencies that provide the highest signal strength.

C. Geographical Areas—The user may select one or more geographical areas of interest. For example, the user may select a particular continent, country, region, state, area code, zip code, city, county, municipality, subdivision, and/or other definable geographical area. According to an exemplary embodiment, such geographical area(s) may be represented in memory 26 by location data, such as one or more Federal Information Processing Standard (FIPS) location codes.

D. Event Types—The user may select one or more types of emergency events which activate the emergency alert function. For example, the user may designate that events such as civil emergencies, radiological hazard warnings, and/or tornado warnings activate the emergency alert function, but that events such as a thunderstorm watch does not, etc. The user may also select whether the conventional warning audio tone provided by the NWS and/or other alert mechanism activates the emergency alert function. According to the present invention, different severity or alert levels (e.g., statement, watch, warning, etc.) may represent different “events.” For example, a thunderstorm watch may be considered a different event from a thunderstorm warning.

E. Alert Outputs—The user may select one or more alert outputs to be provided when the emergency alert function is activated. According to an exemplary embodiment, the user may select visual and/or aural outputs to be provided for each type of emergency event that activates the emergency alert function. For example, the user may select to display a visual message (e.g., an NWS text message as a closed caption display) and/or tune television signal receiver 20 to a specific channel. The user may also for example select to aurally output a warning tone (e.g., chime, siren, etc.) and/or an audio message (e.g., NWS audio message), and the desired volume of each. Moreover, the alert outputs may be selected on an event-by-event basis. Other types of alert outputs may also be provided according to the present invention.

According to the present invention, other menu selections may also be provided at step 501 and/or some of the menu selections described above may be omitted. Data corresponding to the user's selections during the setup process of step 501 is stored in memory 26.

At step 502, television signal receiver 20 monitors the frequency selected by the user during the setup process of step 501 (i.e., item B) for emergency alert signals. According to an exemplary embodiment, tuner 22 monitors the selected frequency and thereby receives incoming emergency alert signals. According to the present invention, television signal receiver 20 is capable of monitoring a frequency and receiving emergency alert signals during all modes of operation, including for example when television signal receiver 20 is turned on, turned off, and/or during playback of recorded audio and/or video content. At step 503, a determination is made as to whether the emergency alert function of television signal receiver 20 is activated. According to an exemplary embodiment, processor 26 makes this determination by comparing data included in the incoming emergency alert signals to data stored in memory 26. As previously indicated herein, the emergency alert signals may include data such as SAME data which represents information including the type of emergency event (e.g., tornado watch, radiological hazard warning, civil emergency, etc.) and the specific geographical area(s) affected by the emergency event. According to an exemplary embodiment, processor 26 compares this SAME data to corresponding user setup data (i.e., items C and D of step 501) stored in memory 26 to thereby determine whether the emergency alert function is activated. In this manner, the emergency alert function of television signal receiver 20 is activated when the emergency event indicated by the emergency alert signals corresponds to: (1) the geographical area(s) selected by the user for item C of step 501 and (2) the event type(s) selected by the user for item D of step 501.

If the determination at step 503 is negative, process flow loops back to step 502 where tuner 22 continues to monitor the selected frequency. Alternatively, if the determination at step 503 is positive, process flow advances to step 504 where processor 26 determines whether television signal receiver 20 is in the on mode (i.e., turned on). If the determination at step 504 is negative, process flow advances to step 505 where processor 26 outputs one or more control signals to thereby switch television signal receiver 20 from the off/standby mode to the on mode.

If the determination at step 504 is positive or following step 505, process flow advances to step 506 where processor 26 determines whether the auxiliary information display function of television signal receiver 20 is enabled. As previously indicated herein, the auxiliary display function of television signal receiver 20 may include a closed caption, teletext or other such display function, and a user may selectively enable or disable the auxiliary display function during the setup process of step 501 by turning the function on or off, respectively. Accordingly, processor 26 determines at step 506 whether the auxiliary display function of television signal receiver 20 is currently turned on.

If the determination at step 506 is negative, process flow advances to step 507 where processor 26 outputs one or more control signals to thereby enable (i.e. turn on) the auxiliary display function of television signal receiver 20. If the determination at step 506 is positive or following step 507, process flow advances to step 508 where processor 26 outputs one or more control signals to thereby enable and provide one or more alert outputs. According to an exemplary embodiment, the alert output(s) provided at step 508 includes an auxiliary information display, such as a closed caption, teletext or other such display.

Other types of alert outputs may also be provided at step 508, and such alert outputs may be aural and/or visual in nature. According to an exemplary embodiment, aural outputs such as a warning tone, an NWS audio message and/or other aural output may be provided at step 508 via speaker 37, and the volume of such aural outputs may be controlled in accordance with the volume level set by the user during the setup process of step 501. Visual outputs may also be provided at step 508 via display 29 to notify individuals of the emergency event. According to an exemplary embodiment, an auxiliary information display such as an NWS text or other message and/or a video output from a specific channel may be provided at step 508 via display 29 under the control of processor 26.

At step 509, processor 26 may output one or more control signals to maintain the original user setting for the auxiliary information display function of television signal receiver 20. Accordingly, if the determination at step 506 was negative (i.e., auxiliary information display function was disabled), processor 26 outputs one or more control signals at step 509 to thereby switch the user setting for the auxiliary information display function back to its original, disabled state. Alternatively, if the determination at step 506 was positive (i.e., auxiliary information display function was enabled), processor 26 simply keeps the user setting for the auxiliary information display function in its current enabled state at step 509. In this manner, the original user setting for the auxiliary information display function of television signal receiver 20 is maintained. According to an exemplary embodiment, step 509 may be initiated after processor 26 detects the end of the SAME data message which ends with a hexadecimal code of “NNNN.”

According to one variation of the steps of FIG. 5, processor 26 may perform steps 506 and 507 every time emergency alert signals are detected, regardless of whether such emergency alert signals activate the emergency alert function of television signal receiver 20. According to this variation, processor 26 may detect the emergency alert signals by detecting the preamble of the SAME data message, which is a hexadecimal code including sixteen bytes of “AB” followed by “ZCZC.” Once the preamble is detected, steps 506 and 507 may be performed. Also according to this variation, step 509 may be performed after processor 26 detects the end of the SAME message, as discussed above. Other variations of the steps of FIG. 5 may also be performed according to the present invention. For example, the SAME message may be processed and stored for possible display at the same time as processor 26 determines whether the emergency alert function is activated. In such a case, processor 26 may enable the auxiliary display function responsive to the preamble of the SAME message, while simultaneously determining whether the emergency alert function is activated. If the emergency alert function is activated, the stored SAME message may then be retrieved from memory 26 for display.

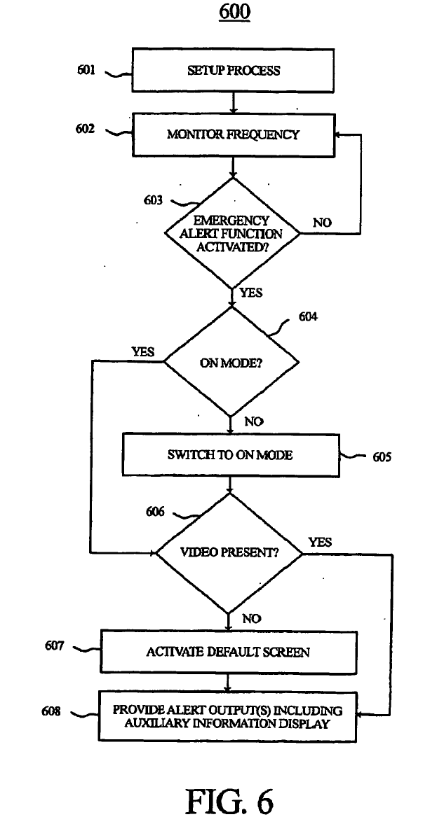

Turning now to FIG. 6, a flowchart 600 illustrating exemplary steps according to another aspect of the present invention is shown. For purposes of example and explanation, the steps of FIG. 6 will be described with reference to television signal receiver 20 of FIG. 2. The steps of FIG. 6 are merely exemplary, and are not intended to limit the present invention in any manner. In FIG. 6, steps 601 to 605 are substantially identical to steps 501 to 505 of FIG. 5, respectively. Accordingly, for clarity of description these steps will not be described again, and the reader may refer to the description of steps 501 to 505 previously provided herein.

At step 606, a determination is made as to whether an active video signal input to television signal receiver 20 is present. According to an exemplary embodiment, processor 26 may detect this condition at step 606 if, for example, a video input of television signal receiver 20 is connected to another video device such as a VCR, DVD player or other device which is turned off. The determination at step 606 may be made using various techniques, such as by detecting valid synchronization signals and/or active AGC signals.

If the determination at step 606 is negative, process flow advances to step 607 where a default screen is activated. According to an exemplary embodiment, the default screen is a blue screen, although other types of default screens may also be used. For example, any default screen which is not derived from an active video source may be used. Accordingly, the default screen activated at step 607 may be some sort of flat video field with or without color information.

If the determination at step 606 is positive or following step 607, process flow advances to step 608 where processor 26 outputs one or more control signals to thereby enable and provide one or more alert outputs. According to an exemplary embodiment, the alert output(s) provided at step 608 includes an auxiliary information display, such as a closed caption, teletext or other such display, which is overlaid upon the default screen. In this manner, the default screen serves as a background for the auxiliary information display and thereby makes the display more easily readable. Other types of alert outputs may also be provided at step 608, such as the aural and/or visual alert outputs previously described herein with reference to step 508. However, it may be desirable to mute audio outputs at step 608 since the auxiliary information display, which may not be linked to audio outputs, may be shorter in duration and more desirable than an audio output message. The decision to mute audio outputs is a matter of user preference, and may be specified by the user through the setup process of step 601.

It should also be appreciated that the principles of the present invention reflected in FIGS. 5 and 6 may be combined. For example, processor 26 may be programmed to perform steps 506 and 507 of FIG. 5, as well as steps 606 and 607 of FIG. 6. In this manner, the receipt of emergency alert signals and/or the activation of the emergency alert function may cause television signal receiver 20 to enable the auxiliary information display function as described at step 507, and also to enable display of a default screen as described at step 607.

As described herein, the present invention provides, among other things, techniques for providing alert outputs which increase the likelihood that users receive important information concerning emergency events. The present invention may be applicable to various apparatuses, either with or without a display device. Accordingly, the phrase “television signal receiver” as used herein may refer to systems or apparatuses capable of receiving and processing television signals including, but not limited to, television sets, computers or monitors that include a display device, and systems or apparatuses such as set-top boxes, VCRs, DVD players, video game boxes, personal video recorders (PVRs), computers or other apparatuses that may not include a display device.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An apparatus having an emergency alert function, comprising:
tuning means for tuning signals including emergency alert signals associated with said emergency alert function; and
processing means for enabling a disabled user setting for an auxiliary information display function of said apparatus responsive to said emergency alert signals.

2. The apparatus of claim 1, wherein said auxiliary information display function includes a closed caption display function.

3. The apparatus of claim 1, wherein said processing means further enables an alert output using said auxiliary information display function responsive to said emergency alert signals.

4. The apparatus of claim 3, wherein said processing means further disables said user setting for said auxiliary information display function after said alert output is enabled.

5. The apparatus of claim 1, wherein said processing means further enables display of a default screen responsive to said emergency alert signals.

6. The apparatus of claim 5, wherein said default screen is a blue screen.

7. The apparatus of claim 5, wherein:
said processing means further enables an alert output using said auxiliary information display function responsive to said emergency alert signals; and
said alert output includes a visual message overlaid upon said default screen.

8. A method for controlling an apparatus having an emergency alert function, comprising:
tuning signals including emergency alert signals associated with said emergency alert function; and
enabling display of a default screen responsive to said emergency alert signals.

9. The method of claim 8, wherein said default screen is a blue screen.

10. The method of claim 8, further comprised of enabling an alert output responsive to said emergency alert signals, and wherein said alert output includes a visual message overlaid upon said default screen.

11. The method of claim 8, further comprised of enabling a disabled user setting for an auxiliary information display function of said apparatus responsive to said emergency alert signals.

12. The method of claim 11, wherein said auxiliary information display function includes a closed caption display function.

13. The method of claim 11, further comprised of enabling an alert output using said auxiliary information display function responsive to said emergency alert signals.

14. The method of claim 13, further comprised of disabling said user setting for said auxiliary information display function after said alert output is enabled.

15. A television signal receiver having an emergency alert function, comprising:
a tuner operative to tune signals including emergency alert signals associated with said emergency alert function; and
a processor operative to enable a disabled user setting for an auxiliary information display function of said television signal receiver responsive to said emergency alert signals.

16. The television signal receiver of claim 15, wherein said auxiliary information display function includes a closed caption display function.

17. The television signal receiver of claim 15, wherein said processor is further operative to enable an alert output using said auxiliary information display function responsive to said emergency alert signals.

18. The television signal receiver of claim 17, wherein said processor is further operative to disable said user setting for said auxiliary information display function after said alert output is enabled.

19. The television signal receiver of claim 15, wherein said processor is further operative to enable display of a default screen responsive to said emergency alert signals.

20. The television signal receiver of claim 19, wherein said default screen is a blue screen.

21. The television signal receiver of claim 19, wherein:
said processor is further operative to enable an alert output using said auxiliary information display function responsive to said emergency alert signals; and
said alert output includes a visual message overlaid upon said default screen.
